(19) United States
(12) Patent Application Publication
(10) Pub. No.: US 2013/0100682 A1
(43) Pub. Date: Apr. 25, 2013

(54) LED LAMP

(71) Applicant: Ta-Sung HSIUNG, TAOYUAN COUNTY (TW)

(72) Inventor: Ta-Sung HSIUNG, TAOYUAN COUNTY (TW)

(73) Assignee: GETAC TECHNOLOGY CORPORATION, HSINCHU (TW)

(21) Appl. No.: 13/423,110

(22) Filed: Mar. 16, 2012

(30) Foreign Application Priority Data
Oct. 20, 2011 (CN) CN201110320132.9

(51) Int. Cl. F21V 29/00; F21V 15/01

(52) U.S. Cl. 362/373; 362/362

(57) ABSTRACT

A LED lamp includes a power supply module and a light emitting module. The power supply module comprises a base and a power supply unit. The base comprises a first combination portion, an electrical connection portion and a screw portion disposed between the first combination portion and the electrical connection portion. The power supply unit is disposed in the base and electrically connected to the electrical connection portion. The light emitting module comprises a housing structure and a light emitting circuit. The housing structure comprises a second combination portion. The light emitting circuit is disposed in the housing structure. The second combination portion is configured to be detachably combined with the first combination portion for electrically connecting/detaching the power supply unit to/from the light emitting circuit.

### BACKGROUND

1. Technical Field

The present disclosure relates to a LED lamp, and more particularly to a LED lamp with a replaceable power supply module.

2. Related Art

Following the trend of eco-conscious, people gradually replace conventional tungsten lamps with Light Emitting Diode (LED) lamps for power-saving purpose. Not only such replacement is environmentally friendly, but also the LED lamp has the advantage of a long service life. Generally speaking, the service life of an LED at a normal temperature may reach 35,000 to 50,000 hours.

However, in reality, the service life of the LED lamp cannot reach 35,000 to 50,000 hours. Specifically, besides the LED, the LED lamp typically further has other elements, such as an electrolytic capacitor with high capacity, a bridge rectifier, a filter, a damper, a rectifier, and a voltage regulator. The LED works with those elements, so that the LED lamp generates light. But, the electrolytic capacitor with high loading or at high temperatures gets broken easily and the broken capacitor will cause a failure in the LED lamp. Conventionally, such LED lamp will be discard—even other elements, except the broken electrolytic capacitor, are still able to function well. However, discarding the LED lamp with functional elements is a waste of money.

### SUMMARY

The present disclosure provides a LED lamp with a replaceable power supply module, to solve the problem in the prior art that the entire lamp needs to be replaced when some of the components in the LED lamp get broken.

An embodiment of the present invention discloses a LED lamp which comprises a power supply module and a light emitting module. The power supply module comprises a base and a power supply unit. The base comprises a first combination portion, an electrical connection portion and a screw portion disposed between the first combination portion and the electrical connection portion. The power supply unit is disposed in the base and electrically connected to the electrical connection portion. The light emitting module comprises a housing structure and a light emitting circuit. The housing structure comprises a second combination portion. The light emitting circuit is disposed in the housing structure. The second combination portion is configured to be detachably combined with the first combination portion for electrically connecting the power supply unit to the light emitting circuit. The power supply module is configured to be combined with or detached from the light emitting module through the first combination portion and the second combination portion, so that a user is able to replace the power supply module.

The power supply module and the light emitting module of the LED lamp are modular-designs, respectively. Accordingly, if the power supply module gets broken, only the broken power supply module is needed to be replaced with a new power supply module. As a result, in comparison with the conventional LED lamp, the service life of the LED lamp is extended.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic three-dimensional view of a LED lamp according to a first embodiment;

FIG. 2 is a schematic exploded view of FIG. 1;

FIG. 3 is a schematic sectional view of FIG. 1; and

FIG. 4 is a schematic block diagram of a power supply circuit in FIG. 1.

### DETAILED DESCRIPTION

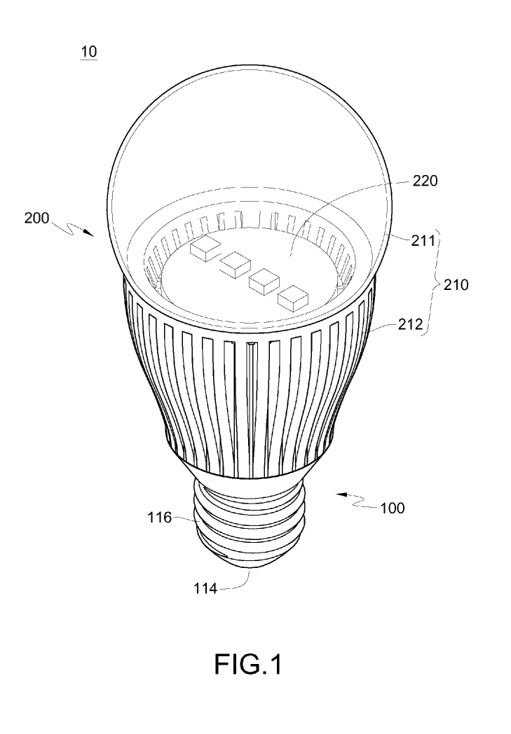

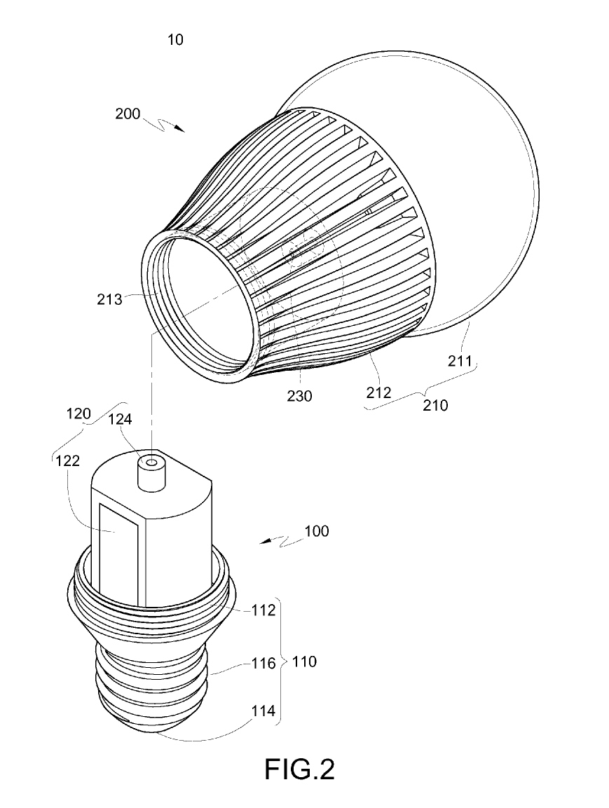

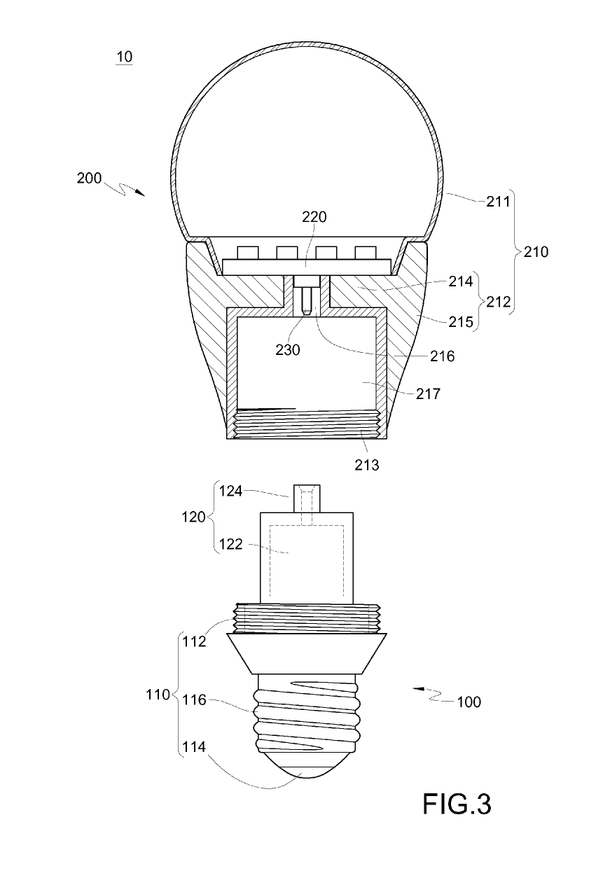

Referring to FIG. 1 to FIG. 3, FIG. 1 is a schematic three-dimensional view of a LED lamp according to a first embodiment, FIG. 2 is a schematic exploded view of FIG. 1, and FIG. 3 is a schematic sectional view of FIG. 1.

The LED lamp 10 comprises a replaceable power supply module 100 and a light emitting module 200.

The power supply module 100 comprises a base 110 and a power supply unit 120. In this and some embodiments, the power supply module 100 is a modular-design. The base 110 comprises a first combination portion 112, an electrical connection portion 114 and a screw portion 116 disposed between the first combination portion 112 and the electrical connection portion 114. In addition, the base 110 has a first accommodation space stretching from the first combination portion 112 to the electrical connection portion 114. The screw portion 116 is configured to be screwed into, for example, a socket which is capable of supplying electricity to the electrical connection portion 114. The base 110, for example, conforms to E14, E27, E40, or MR16 standard.

The power supply unit 120 comprises a power supply circuit 122 and a first electrical connector 124. The first electrical connector 124, the power supply circuit 122 and the electrical connection portion 114 forms a circuit loop. Specifically, one end of the power supply circuit 122 is inserted in the first accommodation space of the base 110 and is electrically connected to the electrical connection portion. The other end of the power supply circuit 122 protrudes from the first accommodation space and is electrically connected to the first electrical connector 124.

In this embodiment, the socket is capable of supplying alternating current (AC). The power supply circuit 122 is configured to convert the AC to direct current (DC). Then, the DC output by the power supply circuit 122 flows to the first electrical connector 124.

The light emitting module 200 comprises a housing structure 210 and a light emitting circuit 220. In this and some embodiments, the light emitting module 200 is a modular-design. The housing structure 210 comprises a second combination portion 213 configured to be detachably connected to the first combination portion 112. In this and some embodiments, the housing structure 210 further comprises an outer bulb 211 and a heat dissipation unit 212. The second combination portion 213 is disposed at an end of the heat dissipation unit 212. The heat dissipation unit 212 comprises a support portion 214 and a plurality of heat dissipation fins 215 protruding from the support portion 214. The support portion 214 has a through hole 216 and a combination groove 217. The combination groove 217 intercommunicates with the through hole 216, and is configured to receive the power supply unit120. The support portion 214 is capped with the outer bulb 211, so that a second accommodation space is formed by them.

The light emitting circuit 220, for example, comprises a circuit board and LEDs electrically connected to the circuit board. The housing structure 210 contains the light emitting circuit 220. The light emitting circuit 220 is disposed in the second accommodation space and on the support portion 214. In this and some embodiments, the light emitting module 200 further comprises a second electrical connector 230. The second electrical connector 230 is electrically connected to the circuit board of the light emitting circuit 220 and disposed in the through hole 216. The second electrical connector 230 is configured to connect to the first electrical connector 124, so that the LEDs of the light emitting circuit 220 may receive the DC output from the first electrical connector 124.

Furthermore, the light emitting circuit 220 is in thermal contact with the support portion 214. Accordingly, the heat generated by the light emitting circuit 220 may be transferred to the heat dissipation fins 215 through support portion 214. In addition, the heat dissipation unit 212 may be an integrally formed structure. In other words, the support portion 214 and the heat dissipation fins 215 are formed from a single piece of material.

With respect to the first combination portion 112 and the second combination portion 213, both of them have screw threads, respectively. Therefore, the second combination portion 213 may be combined with or detached from the first combination portion 112 by rotating one of them with respect to the other. However, this embodiment is not intended to limit ways to detachably combine the second combination portion 213 with the first combination portion 112. In some embodiments, the second combination portion 213 may be detachably combined with the first combination portion 112 by, for example, snap connection.

In this and some embodiments, the first electrical connector 124 is electrically connected to the second electrical connector 230 when the first combination portion 112 is combined with the second combination portion 230. Accordingly, with the first combination portion 112 and the second combination portion 230, the power supply circuit 122 may be electrically connected to the light emitting circuit 220.

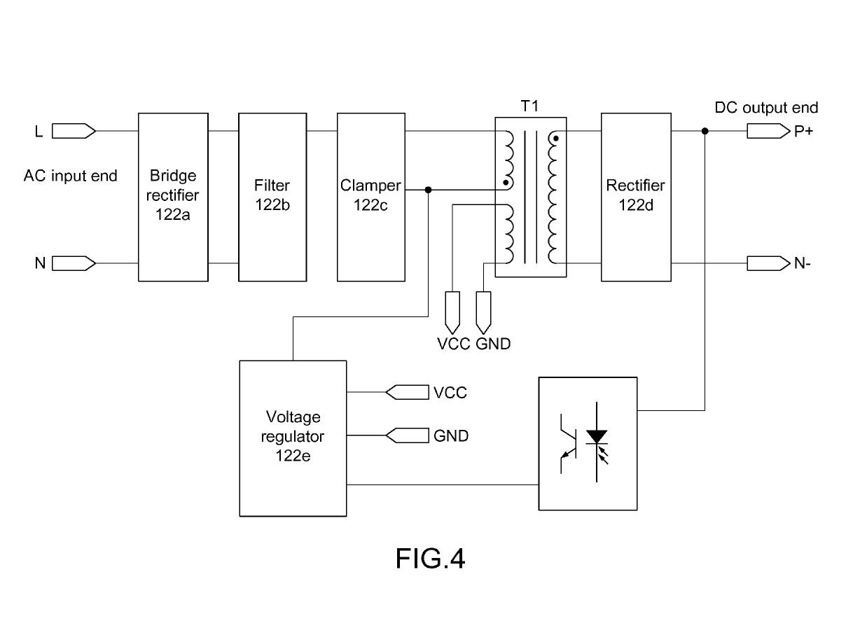

FIG. 4 is a schematic block diagram of the power supply circuit in FIG. 1. The power supply circuit 120 comprises a bridge rectifier 122a, a filter 122b, a damper 122c, a DC rectifier 122d and a voltage regulator 122e. The bridge rectifier 122a is configured to convert the AC into the DC. However, the voltage of the DC output by the bridge rectifier 122a is not constant. The filter 122b is used to smooth the voltage waveform of the DC output by the bridge rectifier 122a. Then, the voltage of the DC is shifted up or shifted down by the damper 122c without changing the voltage waveform of the DC output by filter 122b. After that, the voltage waveform of the DC is adjusted by the DC rectifier 122d. However, in the power supply circuit 122, electrolytic capacitors with high capacity are typically disposed at an output end of the bridge rectifier 122a, at an output end of the filter 122b and at the DC rectifier 122d. In addition, some electrolytic capacitors are further disposed between the voltage regulator 122e and a voltage supply Vcc. Those electrolytic capacitors are easily overloaded and then damaged. Once one of the electrolytic capacitor gets broken, the power supply module 100 is not able to supply electricity to the light emitting module 200. Accordingly, the service life of the power supply module 100 is much shorter than that of the light emitting module 200

With respect to the conventional LED lamp, if some of the electrolytic capacitors of the LED lamp breaks down, and therefore, cause the LED lamp to fail, the entire LED lamp will be discarded. In contrast, the power supply module 100 and the light emitting module 200 of the LED lamp 10 are modular-designs respectively. Accordingly, if the power supply module 100 of the LED lamp 10 gets broken, only the broken power supply module 100 is needed to be replaced with a new power supply module 100. As a result, in comparison with the conventional LED lamp, the service life of the LED lamp 10 is extended.

In addition, the first electrical connector 124 and the second electrical connector 230 of this embodiment are respectively and correspondingly a male connector and a female connector. For example, the first electrical connector 124 is a hollow cylinder, and the second electrical connector 230 is a groove with a corresponding shape. When the first combination portion 111 and the second combination portion 213 have screw threads, the first electrical connector 124 and the second electrical connector 230 are disposed in positions through which a central axis of the LED lamp 10 passes. Therefore, when the first electrical connector 124 rotates with respect to second electrical connector 230 in order to combine/detach the power supply module 100 with/from the light emitting module 200, the second electrical connector 230 will not push against the first electrical connector 124 in the radial direction. As a result, during the process of replacing the power supply module 100 or the light emitting module 200, the probability of breaking the inner wires of the LED lamp is lowered. However, this embodiment is not intended to limit the type of the first electrical connector 124 and the second electrical connector 230. In some embodiment, the first electrical connector 124 may be a female connector, and the second electrical connector 230 may be a male connector.

However, if the first combination portion 111 is combined with the second combination portion 213 by snap connection, the direction in which the first electrical connector 124 connect to the second electrical connector 230 is typically parallel to the direction in which the first combination portion 111 snaps in the second combination portion 213. Accordingly, the first electrical connector 124 and the second electrical connector 230 may be located in positions through which the center axial center does not pass.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A LED lamp, comprising:
a power supply module, comprising a base and a power supply unit, the base comprising a first combination portion, an electrical connection portion and a screw portion disposed between the first combination portion and the electrical connection portion, and the power supply unit being disposed in the base and being electrically connected to the electrical connection portion; and
a light emitting module, comprising a housing structure and a light emitting circuit, the housing structure comprising a second combination portion, the light emitting circuit being disposed in the housing structure, and the second combination portion being configured to be detachably combined with the first combination portion for electrically connecting the power supply unit to the light emitting circuit;
wherein the power supply module is configured to be combined with or detached from the light emitting module through the first combination portion and the second combination portion, so that a user is able to replace the power supply module.

2. The LED lamp according to claim 1, wherein the power supply unit comprising a power supply circuit and a first electrical connector, the power supply circuit is inserted in the base, the first electrical connector is electrically connected to the power supply circuit, the light emitting module further comprises a second electrical connector electrically connected to the light emitting circuit, and the second electrical connector is configured to be electrically connected to the first electrical connector.

3. The LED lamp according to claim 2, wherein the first electrical connector is a female connector and the second electrical connector is a male connector.

4. The LED lamp according to claim 2, wherein the first electrical connector is a male connector and the second electrical connector is a female connector.

5. The LED lamp according to claim 1, wherein the power supply circuit comprises a bridge rectifier, a filter, a damper, a DC rectifier and a voltage regulator.

6. The LED lamp according to claim 1, wherein the housing structure comprises a heat dissipation unit and an outer bulb disposed at one end of the heat dissipation unit, and the second combination portion is disposed at another end of the heat dissipation unit.

7. The LED lamp according to claim 6, wherein the heat dissipation unit comprises a support portion and a plurality of heat dissipation fins protruding from the support portion, the light emitting circuit is disposed on the support portion and is capped with the outer bulb.

8. The LED lamp according to claim 7, wherein the support portion has a combination groove for receiving the power supply unit.

9. The LED lamp according to claim 8, wherein the support portion has a through hole, the through hole intercommunicates with the combination groove, and the second electrical connector is disposed in the through hole.

10. The LED lamp according to claim 1, wherein the base conforms to the MR16 standard.

11. The LED lamp according to claim 1, wherein the base conforms to the E14, E27 or E40 standard.
